(19) United States
(12) Patent Application Publication
(10) Pub. No.: US 2011/0097498 A1
(43) Pub. Date: Apr. 28, 2011

(54) METHOD FOR INHIBITING GROWTH OF TIN WHISKERS

(75) Inventors: Yee-Wen Yen, Taipei (TW); Chao-Kang Li, Taipei (TW); Meng-Yu Tsou, Taipei (TW)

(73) Assignee: NATIONAL TAIWAN UNIVERSITY OF SCIENCE & TECHNOLOGY, Taipei (TW)

(21) Appl. No.: 12/702,327

(22) Filed: Feb. 9, 2010

(30) Foreign Application Priority Data
Oct. 28, 2009 (TW) 098136420

(51) Int. Cl. B05D 3/02; C22F 1/00; C25D 5/34

(52) U.S. Cl. 427/319; 148/527; 205/209

(57) ABSTRACT

A method for inhibiting growth of tin whiskers is provided. The method includes providing a metal substrate, treating the metal substrate by an annealing process, and forming a tin layer to cover a surface of the metal substrate, wherein the surface of the tin layer has no tin whisker.

### CROSS REFERENCE TO RELATED APPLICATIONS

This Application claims priority of Taiwan Patent Application No. 98136420, filed on Oct. 28, 2009, the entirety of which is incorporated by reference herein.

### BACKGROUND OF THE INVENTION

1. Field of the Invention

The invention relates to a method for inhibiting growth of tin whiskers, and more particularly to a method for inhibiting growth of tin whiskers in connecting elements of electronic device packages.

2. Description of the Related Art

Currently, copper or an iron-nickel alloy is the major material of lead frames for electronic device packages for providing carriers of chips and electrically connecting chips to print circuit boards. Because the bonding strengths between these two kinds of lead frame materials and the print circuit boards are poor, a solder layer is coated on the surface of the lead frame to improve the bonding strength between the lead frame and the print circuit board.

Generally, a tin-lead alloy is used for the solder layer on the surface of the lead frame. Because lead is toxic and harmful to the environment, a lead-free solder is used to substitute the conventional tin-lead solder. However, at room temperature, the lead-free solder spontaneously grows tin whiskers. When the tin whiskers grow to a certain length, two adjacent pins of the lead frame become connected by the tin whiskers and a short occurs between the two adjacent pins of the lead frame. Moreover, when the tin whiskers grow to a length close to a pitch between the two adjacent pins of the lead frame, a point discharge occurs at the pins of the lead frame and a spark is produced by the point discharge of the pins to make the packaged electronic devices fail.

The three conventional methods for inhibiting the growth of tin whiskers are listed blow:

1. Changing the thickness of the solder layer: the solder layer having a thickness less than 0.5 μm or greater than 20 μm is used for inhibiting growth of tin whiskers. However, a bridge formation easily occurs in thick solder layers which are applied to tiny products, the risk of an electrical short thereby increases. Meanwhile, the thin solder layer is less effective in stopping corrosion and providing stability etc.

2. Using an alloy coating as a barrier layer: a nickel alloy or a silver alloy layer is formed between the solder layer and a copper substrate as a barrier layer to inhibit growth of tin whiskers. However, under the effects of thermal expansion, the coefficient difference between the materials of the solder layer, the barrier layer and the copper substrate causes compression stress to form in multi-layered metal structure or an inter-metallic compound layer to induce the growth of tin whiskers.

3. Performing an annealing treatment: a structure of the solder layer and the copper substrate are treated with an annealing process at a temperature below the melting point of tin, i.e. 231.89° C. to inhibit growth of tin whiskers. However, an inter-metallic compound formation is accelerated in the structure treated by the above mentioned annealing process, such that the bonding ability of the solder layer is decreased and the soldering ability of pins of a lead frame is reduced. Meanwhile, the color of the surface of the solder layer is changed during the annealing process and the soldering ability of the solder layer is also reduced.

Therefore, a method for inhibiting growth of tin whiskers which can overcome the above problems and effectively inhibit the growth of tin whiskers is desired

### BRIEF SUMMARY OF THE INVENTION

An embodiment of the invention provides a method for inhibiting growth of tin whiskers. In an embodiment of the invention, a metal substrate is first implemented with an annealing process and then covered with a tin layer thereon. This method can effectively inhibit growth of tin whiskers in the tin layer.

According to an embodiment of the invention, the method for inhibiting growth of tin whiskers comprises providing a metal substrate; performing an annealing process to the metal substrate; and forming a tin layer to cover a surface of the metal substrate, wherein the tin layer is formed without tin whiskers.

A detailed description is given in the following embodiments with reference to the accompanying drawings.

### BRIEF DESCRIPTION OF THE DRAWINGS

The invention can be more fully understood by reading the subsequent detailed description and Examples with reference to the accompanying drawings, wherein:

FIG. 1 shows a flow chart of a method for inhibiting growth of tin whiskers according to an embodiment of the invention;

FIG. 2 shows a schematic cross section of a structure according to each Example and each Comparative Example of the invention;

FIG. 3A shows a photograph of a matte tin layer taken by a scanning electron microscope (SEM) according to the Example 1 of the invention;

FIG. 3B shows a photograph of a matte tin layer taken by a scanning electron microscope (SEM) according to the Comparative Example 1 of the invention;

FIG. 4A shows a photograph of a matte tin layer taken by scanning electron microscope (SEM) according to the Example 2 of the invention;

FIG. 4B shows a photograph of a matte tin layer taken by scanning electron microscope (SEM) according to the Comparative Example 2 of the invention;

FIG. 5A shows a photograph of a matte tin layer taken by scanning electron microscope (SEM) according to the Example 3 of the invention;

FIG. 5B shows a photograph of a matte tin layer taken by a scanning electron microscope (SEM) according to the Comparative Example 3 of the invention;

FIG. 6A shows a photograph of a matte tin layer taken by a scanning electron microscope (SEM) according to the Example 4 of the invention; and

FIG. 6B shows a photograph of a matte tin layer taken by a scanning electron microscope (SEM) according to the Comparative Example 4 of the invention.

### DETAILED DESCRIPTION OF THE INVENTION

The following description is of the best-contemplated mode of carrying out the invention. The description is provided for illustrating the general principles of the invention and is not meant to be limiting. The scope of the invention is best determined by reference to the appended claims.

In an embodiment of the invention, a method for inhibiting growth of tin whiskers is provided. First, a metal substrate is provided to perform an annealing process. Then, a tin layer is formed on a surface of the metal substrate, such that growth of tin whiskers in the tin layer is inhibited. The metal substrate with the tin layer covering thereon can be used for a connecting element of electronic device packages. The connecting element makes an electronic device, for example a chip, electrically connect to an external circuit, for example a print circuit board. The connecting element can be applied to a surface mount technology (SMT) or a pin through hole (PTH) bonding technology for pins of a lead frame or a ball grid array (BGA) structure of a flip-chip bonding.

Referring to FIG. 1, a flow chart of a method for inhibiting growth of tin whiskers according to an embodiment of the invention is shown. First, in the step S100, a metal substrate is provided. In an embodiment, the metal substrate may be copper or an iron-nickel alloy.

Next, in the step S102, the metal substrate is treated by an annealing process. In an embodiment, the annealing process is performed in a vacuum environment. The temperature of the annealing process may be between about 300° C. and 700° C. The time of the annealing process may be about one hour to about three hours.

Then, in the step S104, a tin layer is formed to cover the surfaces of the metal substrate. In an embodiment, the tin layer may be a lead-free complete tin layer formed by an electroplating process to cover all surfaces of the metal substrate. The tin layer may be a matte tin or a bright tin. In addition, the thickness of the tin layer may be between about 3 μm and about 20 μm.

Then, the structure of the metal substrate with the tin layer covering thereon is tested in an environment suitable for tin whisker growth to determine whether tin whiskers will grow. For example, the structure is heated to a temperature of 60° C. and maintained at that temperature for 250 hours in order to implement an accelerated test. As a result of the test, the method for inhibiting growth of tin whiskers according to an embodiment of the invention is effective.

The growth of tin whiskers results from an irreversible action of increasing and decreasing stress, which produces tiny mono-crystals, i.e. tin whiskers, spontaneously growing on the surface of the tin layer. The tin whiskers protrude from the surface of the tin layer. A major driving force for the growth of tin whiskers is compressive stress, which may originate from an internal stress in the tin layer and an external stress outside the tin layer. The internal stress is mainly produced from the occurrence of impure atoms during the electroplating process, a mismatch of thermal expansion coefficients between the tin layer and the metal substrate, a volume change caused by oxides formed on the surface of the tin layer and an inter-metallic compound (IMC) formed by inter-diffusing between the tin layer and the metal substrate. The external stress may be produced from a compression between several layers of the tin layer during disposing of the electroplate element containing the tin coating layers or by an external pressure applied on the surface of the tin layer. Additionally, tin layer scratches, a storage environment of the electroplate element, the thickness of the tin layer, a crystal status of the tin layer and an electroplating condition, etc. may affect the growth of tin whiskers.

In an embodiment of the invention, firstly, the metal substrate is treated by an annealing process, such that metal atoms of the metal substrate are arranged by redistribution. As a result, it can prevent the tin layer subsequently formed on the metal substrate from producing the internal stress and thus help to effectively inhibit the growth of tin whiskers.

The methods for inhibiting the growth of tin whiskers and the results thereof are described in detail by several Examples and Comparative Examples discussed below:

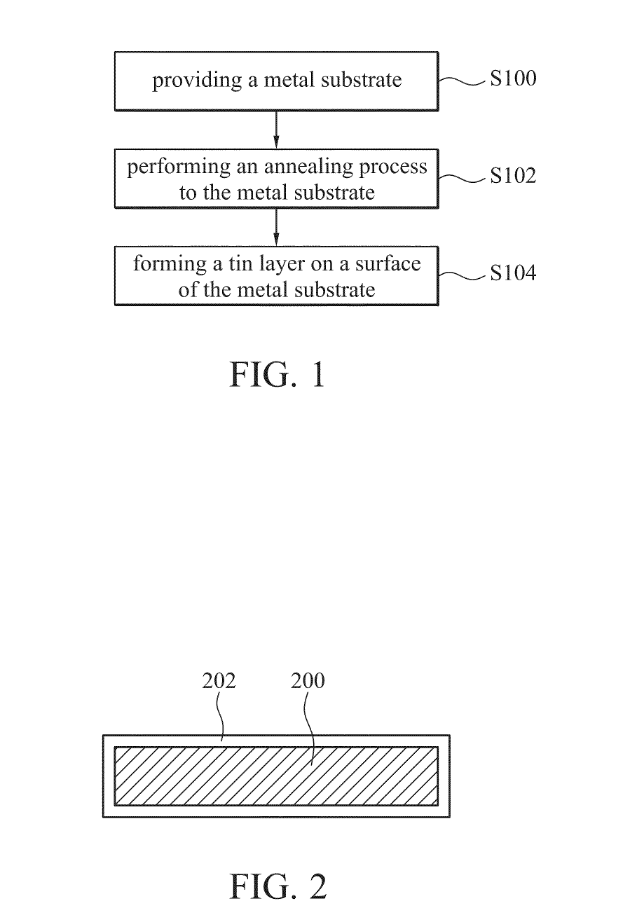

A cross section of the structure of each Example and Comparative Example was shown in FIG. 2. A copper plate was used for a substrate 200 and a matte tin layer 202 was electroplated onto the surface of the substrate 200. The structure of each example and comparative example was put in an environment of 60° C. to for a duration of 250 hours in order to implement an accelerated test to determine whether the tin layer 202 produced whiskers.

### Examples 1-4

The copper plates were polished and burnished to make the surfaces of the copper plates smooth and to remove oxides and impurities thereon. Then, the copper plates were disposed in a vacuum environment of about 10⁻³ torr by sealing in a vacuum tube to avoid the copper plates from oxidization. Next, the copper plates were treated by an annealing process of 650° C. for 3 hours.

Then, the copper plates treated with the annealing process were disposed in a room temperature environment to cool down. The copper plates were measured by a four-point probe method to determine the sheet resistance thereof, and the result was shown in Table 1. Next, the copper plates were measured by an electron probe micro-analyzer (EPMA) to determine the oxygen content of the copper plates treated with the annealing process, and the result was shown in Table 1.

Then, the copper plates were exposed to an electroplating process which coats the surface of the copper plates with a tin layer. The electroplating equipment for the electroplating process consisted of a cathode and an anode corresponding to the cathode. A direct current power supplier was provided for supplying a current to the electroplating equipment to form a circuit between the cathode and the anode. Moreover, in an electroplating tank, a magnet stirrer was provided for stirring an electroplating solution therein to make sure of the uniformity of tin ions in the electroplating solution during the electroplating process and the uniformity of the tin layers formed thereby.

The current densities of the electroplating conditions for the Examples 1-4 were 5, 10, 15 and 20 Amp/dm² (ASD), respectively. The time of the electroplating process for the Examples 1-4 were both one minute. As a result, the thicknesses of the tin layers of the Examples 1-4 were 3, 6, 9 and 12 nm, respectively.

Then, the structures of the Examples 1-4 were disposed at an environment of 60° C. for 250 hours to implement an accelerated test. After the accelerated test, the tin layers were measured by a scanning electron microscope (SEM). As shown in the results of the Examples 1-4, there were no tin whiskers on the surface of the tin layers.

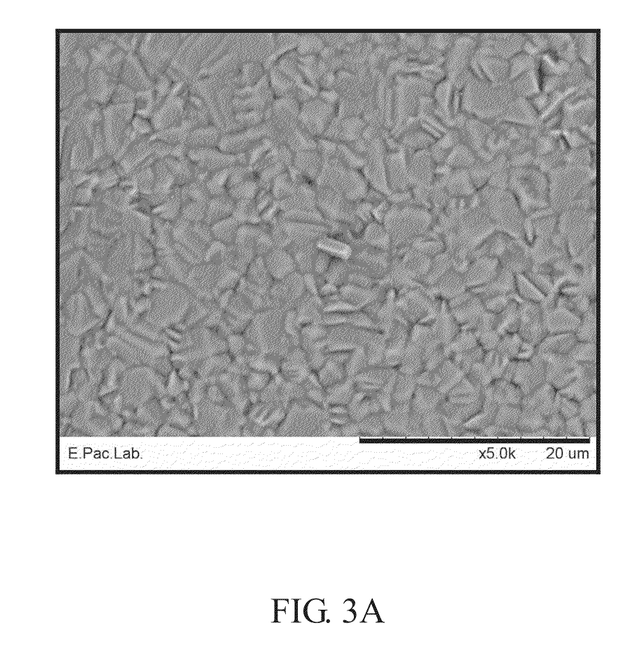

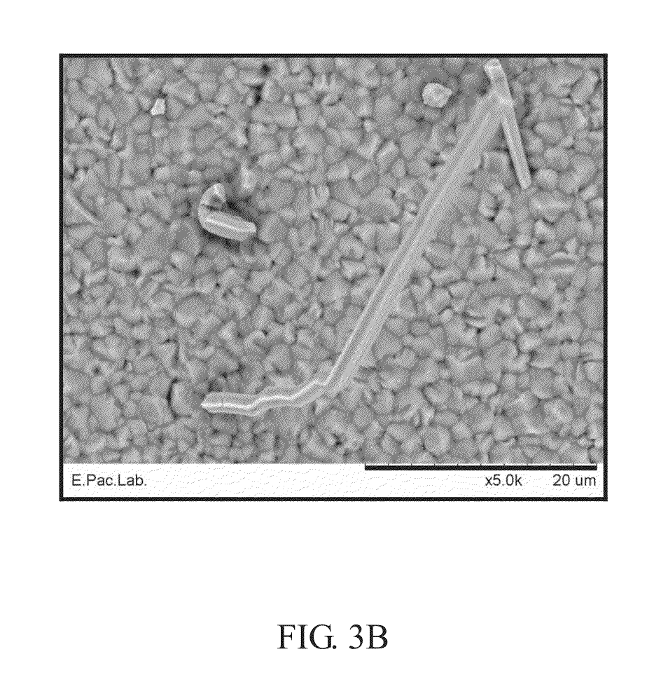

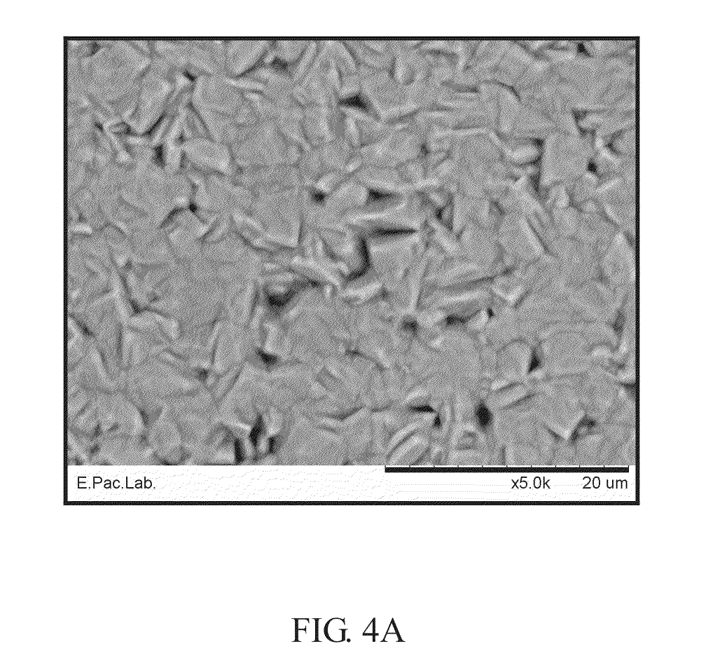

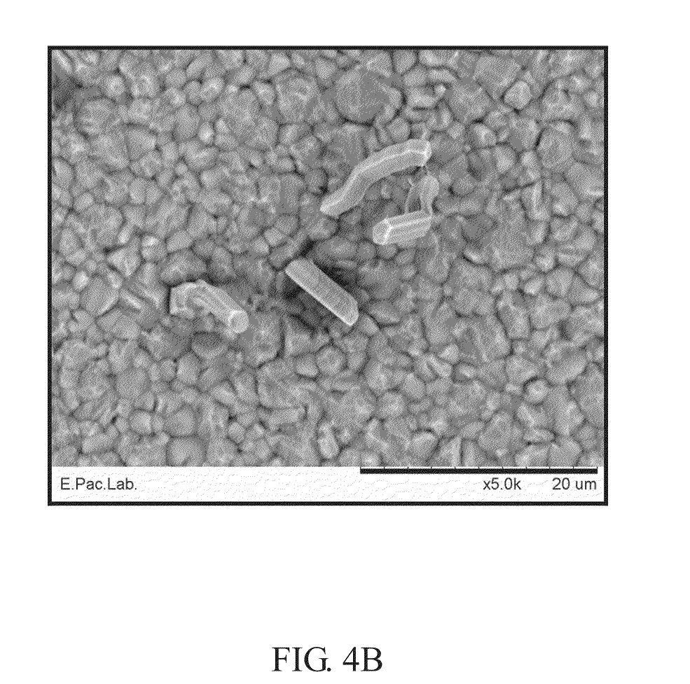

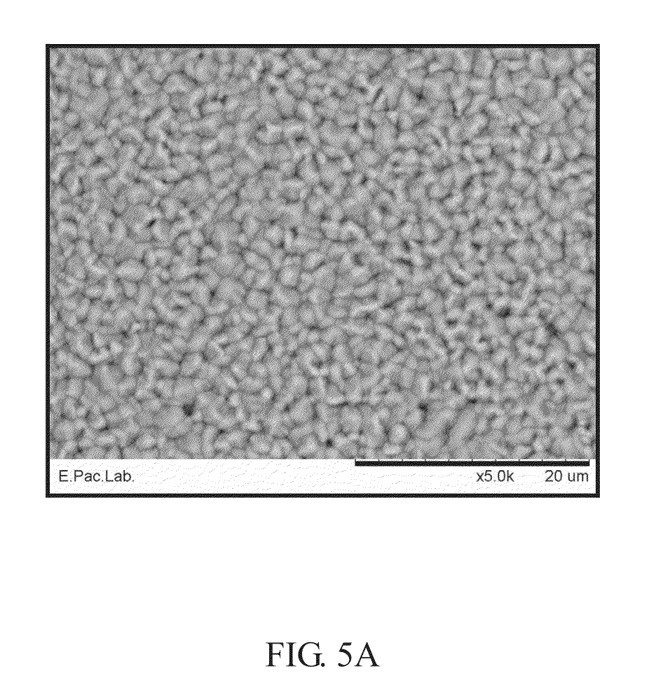

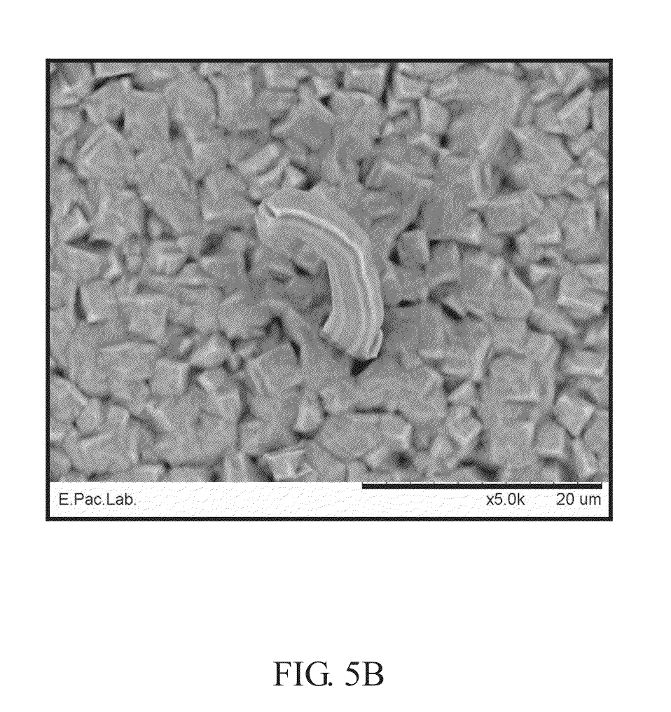

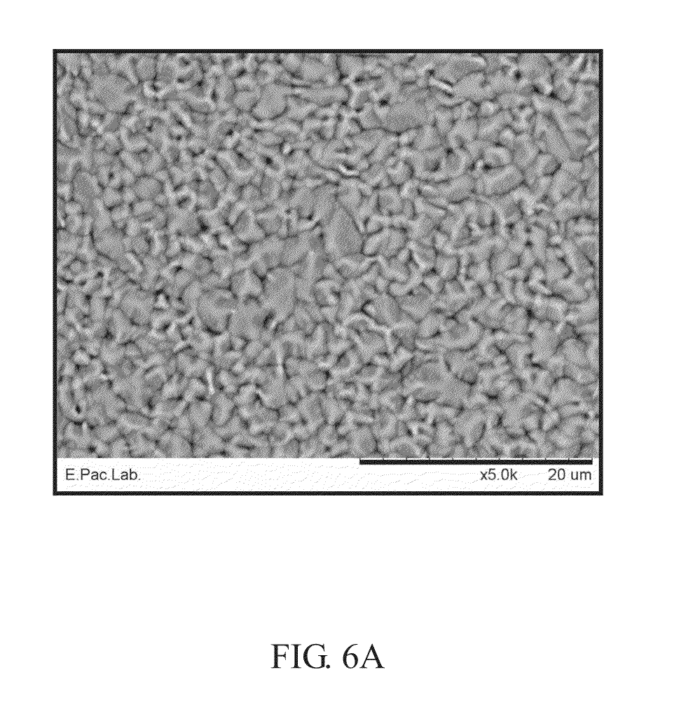

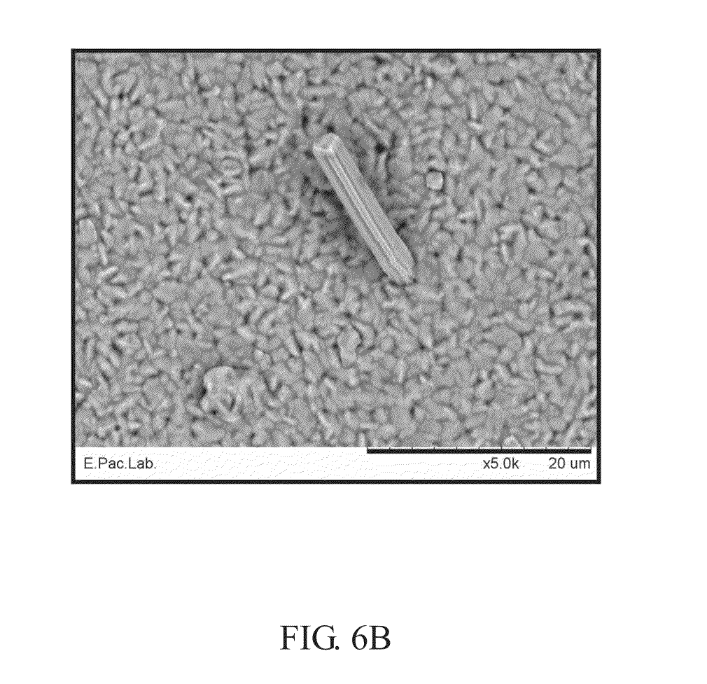

The photographs of the tin layers taken by scanning electron microscope (SEM) according to the Examples 1-4 are shown in FIGS. 3A, 4A, 5A and 6A, respectively.

### Comparative Examples 1-4

The copper plates were polished and burnished to make the surfaces of the copper plates smooth and to remove oxides and impurities thereon.

Then, the copper plates of the Comparative Examples 1-4, which were not treated with an annealing process were measured by a four-point probe method to determine the sheet resistance thereof, and the result was shown in Table 1. Next, the copper plates of the Comparative Examples 1-4 were measured by an electron probe micro-analyzer (EPMA) to determine the oxygen content of the copper plates which were not treated with an annealing process, and the result was shown in Table 1.

Then, the copper plates of the Comparative Examples 1-4, which were not treated with an annealing process, were subject to an electroplating process to coat them with a tin layer thereon. The electroplating equipment for the Comparative Examples 1-4 was the same as that of the Examples 1-4. The current densities of the electroplating conditions for the Comparative Examples 1-4 were 5, 10, 15 and 20 Amp/dm² (ASD), respectively. The time of the electroplating process for the Comparative Examples 1-4 was one minute. According to the results, the thicknesses of the tin layers of the Comparative Examples 1-4 were 3, 6, 9 and 12 μm, respectively.

Then, the structures of the Comparative Examples 1-4 were disposed at an environment of 60° C. for a period of 250 hours in order to implement an accelerated test. After the accelerated test, the tin layers of the Comparative Examples 1-4 were measured by a scanning electron microscope (SEM). As shown in the results of the Comparative Examples 1-4, tin whiskers did form on the surfaces of the tin layers.

The photographs of the tin layers taken by the scanning electron microscope (SEM) according to the Comparative Examples 1-4 were shown in FIGS. 3B, 4B, 5B and 6B, respectively.

TABLE 1
the characteristics of the copper substrates of the Examples and the
Comparative Examples

| | | the substrates |
|---|---|---|
| | the substrates | of Comparative |
| | of Examples | Examples 1-4 (without |
| | 1-4 (with annealing) | annealing) |
| sheet resistance (Ω-m) | 0.6 × 10⁻⁸ | 0.8 × 10⁻⁸ |
| oxygen content (atom %) | 1.15 | 1.05 |

As shown in the results of Table 1, the sheet resistances of the copper plates which were subject to the annealing treatment are essentially the same as that of the copper plates without annealing treatment. Accordingly, the conductivities of the copper plates are not affected by the annealing treatment for the copper plates as shown by the Examples. Moreover, the oxygen content of the copper plates which underwent the annealing treatment was essentially the same as that of the copper plates which did not undergo the annealing treatment. Accordingly, there is no oxidization after the annealing treatment for the copper plates of the Examples.

As shown in the results of the photographs of the tin layers from the examples and the comparative examples taken by a scanning electron microscope (SEM); performing the annealing process to the copper plate before electroplating the tin layer is advantageous for effectively inhibiting growth of tin whiskers in the tin layer.

As mentioned above, in an embodiment of the invention, the method for inhibiting growth of tin whiskers includes firstly performing an annealing process to the metal substrate, and then electroplating the thin layer on the surface of the metal substrate. Thus, effective inhibition of tin whisker is achieved.

The method for inhibiting the growth of tin whiskers according to the invention can be applied to connecting elements of various electronic device package technologies. Moreover, the method of the invention can also be applied to any structure needed to form a tin layer on a metal substrate and needed to inhibit growth of tin whiskers in the tin layer.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for inhibiting growth of tin whiskers, comprising:
providing a metal substrate;
performing an annealing process to the metal substrate; and
forming a tin layer, covering the surface of the metal substrate, wherein the tin layer is formed without tin whiskers.

2. The method as claimed in claim 1, wherein the metal substrate comprises copper or an iron-nickel alloy.

3. The method as claimed in claim 1, wherein the annealing process is implemented at a temperature between 300° C. and 700° C.

4. The method as claimed in claim 3, wherein the step of performing the annealing process is implemented in a vacuum environment.

5. The method as claimed in claim 3, wherein the annealing process is implemented at a time between 1 hour and 3 hours.

6. The method as claimed in claim 1, wherein the step of forming the tin layer comprises an electroplating process.

7. The method as claimed in claim 1, wherein the tin layer has a thickness between 3 μm and 20 μm.

8. The method as claimed in claim 1, wherein the tin layer is a lead free tin layer.

9. The method as claimed in claim 1, wherein the tin layer comprises a matte tin or a bright tin.

10. The method as claimed in claim 1, wherein the tin layer has no tin whisker grown therein, after performing a heating process of 60° C. and 250 hours to the tin layer.

11. The method as claimed in claim 1, wherein the metal substrate covered with the tin layer thereon is used for a connecting element between an electronic device package and an external circuit.

12. The method as claimed in claim 11, wherein the electronic device package comprises a chip package and the external circuit comprises a print circuit board.

13. The method as claimed in claim 11, wherein the connecting element comprises a pin of a lead frame or a ball grid array for a flip-chip bonding.

14. The method as claimed in claim 1, wherein a conductivity of the metal substrate before performing the annealing process is substantially the same as a conductivity of the metal substrate after performing the annealing process.

15. The method as claimed in claim 1, wherein the metal substrate before performing the annealing process has an oxygen content substantially the same as a oxygen content of the metal substrate after performing the annealing process.
